(19) United States
(12) Patent Application Publication
(10) Pub. No.: US 2025/0117951 A1
(43) Pub. Date: Apr. 10, 2025

(54) INFORMATION PROCESSING DEVICE, INFORMATION PROCESSING METHOD, AND RECORDING MEDIUM

(71) Applicant: Sony Group Corporation, Tokyo (JP)

(72) Inventor: Toshiyuki SASAKI, Tokyo (JP)

(73) Assignee: Sony Group Corporation, Tokyo (JP)

(21) Appl. No.: 18/729,175

(22) PCT Filed: Jan. 30, 2023
(86) PCT No.: PCT/JP2023/002806

§ 371 Date: Jul. 16, 2024

(30) Foreign Application Priority Data
Feb. 15, 2022 (JP) 2022-021022

(51) Int. Cl. G06T 7/215; G01S 17/89; G06V 10/80; G06V 10/98

(52) U.S. Cl. CPC G06T 7/215; G01S 17/89; G06V 10/803; G06V 10/98

(57) ABSTRACT

There is provided an information processing device, an information processing method, and a recording medium that further improve the accuracy of object tracking. A correction unit corrects, based on a tracking result of an object based on 2D tracking using an optical flow and 3D tracking using a depth, errors of the optical flow and the depth, and an update unit updates the tracking result based on the corrected optical flow and depth. The present disclosure can be applied, for example, to a moving body detection device mounted on an autonomous driving vehicle.

### TECHNICAL FIELD

The present disclosure relates to an information processing device, an information processing method, and a recording medium, and more particularly to an information processing device, an information processing method, and a recording medium that further improve the accuracy of object tracking.

### BACKGROUND ART

Many conventional moving body detection and motion prediction technologies aimed at achieving autonomous driving of vehicles are known.

For example, PTL 1 discloses a technology that performs object tracking using the detection result of an object and an optical flow of a feature points, and estimates the state of the object, such as its position and velocity, based on the tracking result and the distance to the feature point.

### CITATION LIST

### Patent Literature

PTL 1:
JP 2020-126394A

### SUMMARY

### Technical Problem

However, with the technology of PTL 1, when the accuracy of the optical flow decreases due to various factors, there is a possibility that the accuracy of object tracking will also decrease.

The present disclosure has been made in view of such circumstances, and aims to further improve the accuracy of object tracking.

### Solution to Problem

An information processing device according to the present disclosure is an information processing device including: a correction unit that corrects, based on a tracking result of an object based on 2D tracking using an optical flow and 3D tracking using a depth, errors of the optical flow and the depth; and an update unit that updates the tracking result based on the corrected optical flow and depth.

An information processing method according to the present disclosure is an information processing method including: by an information processing device, correcting, based on a tracking result of an object based on 2D tracking using an optical flow and 3D tracking using a depth, errors of the optical flow and the depth; and updating the tracking result based on the corrected optical flow and depth.

A recording medium according to the present disclosure is a computer-readable recording medium having recorded thereon a program for executing processing of correcting, based on a tracking result of an object based on 2D tracking using an optical flow and 3D tracking using a depth, errors of the optical flow and the depth; and updating the tracking result based on the corrected optical flow and depth.

In the present disclosure, based on a tracking result of an object based on 2D tracking using an optical flow and 3D tracking using a depth, errors of the optical flow and the depth is corrected; and the tracking result is updated based on the corrected optical flow and depth.

### BRIEF DESCRIPTION OF DRAWINGS

FIG. 1 is a block diagram illustrating a configuration example of a moving body detection device to which the technology according to the present disclosure is applied.

FIG. 2 is a block diagram illustrating a configuration example of a feature extraction unit.

FIG. 3 is a block diagram illustrating a functional configuration example of a tracking unit.

FIG. 4 is a flowchart illustrating a flow of 2D tracking processing.

FIG. 5 is a flowchart illustrating a flow of 3D tracking processing.

FIG. 6 is a flowchart illustrating a flow of tracking result integration processing.

FIG. 7 is a block diagram illustrating a functional configuration example of an alternating optimization unit and a register.

FIG. 8 is a flowchart illustrating an operation flow of the alternating optimization unit.

FIG. 9 is a flowchart illustrating an operation flow of the register.

FIG. 10 is a diagram illustrating network optimization.

FIG. 11 is a block diagram illustrating a configuration example of a computer.

### DESCRIPTION OF EMBODIMENTS

Hereinafter, modes for carrying out the present disclosure (hereinafter referred as embodiments) will be described. The description will be made in the following order.
1. Issue of Conventional Technology and Overview of Technology According to Present Disclosure
2. Moving Object Detection Device to which Technology According to Present Disclosure Is Applied
3. Configuration of Feature Extraction Unit
4. Configuration and Operation of Tracking Unit
5. Configuration and Operation of Alternating Optimization Unit and Register
6. Optimization of Network
7. Configuration Example of Computer

### <1. Issue of Conventional Technology and Overview of Technology According to Present Disclosure>

To achieve safe autonomous driving in typical urban areas, more sophisticated motion detection and prediction technologies are required.

Among these, PTL 1 discloses a technology that performs object tracking using the detection result of an object and an optical flow of a feature point, and estimates the state of the object, such as its position and velocity, based on the tracking result and the distance (depth) to the feature point.

However, with the technology of PTL 1, when the accuracy of the optical flow decreases due to various factors, there is a possibility that the accuracy of object tracking will also decrease. In contrast, with the technology according to the present disclosure, an object is tracked using each of optical flow and depth, thereby achieving highly accurate object tracking even when the accuracy of the optical flow decreases.

Furthermore, with the technology of PTL 1, the result of tracking of the object is simply used to predict the state of the object, and the accuracy of the optical flow and the depth does not change before and after processing. In contrast, with the technology according to the present disclosure, errors of the optical flow and the depth are corrected using the tracking result, and the corrected optical flow and depth are fed back to the object tracking, thereby improving the accuracy of the optical flow and the depth, and even the object tracking.

<2. Moving Object Detection Device to which Technology According to Present Disclosure Is Applied>

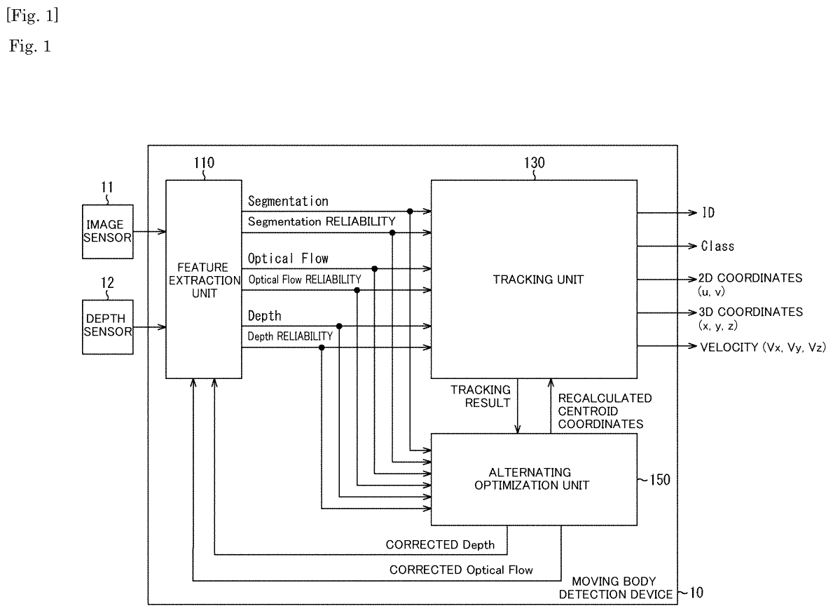

FIG. 1 is a diagram illustrating a configuration example of a moving body detection device to which the technology according to the present disclosure is applied.

The moving body detection device 10 illustrated in FIG. 1 is configured as an information processing device (computer) mounted on, for example, an autonomous driving vehicle. The moving body detection device 10 detects and tracks a moving body nearby, such as another vehicle, a bicycle, a pedestrian, and a railroad car, based on image data from an image sensor 11 and sensor data from a depth sensor 12.

The image sensor 11 is composed of an RGB camera, and outputs an RGB image as image data to the moving body detection device 10. The depth sensor 12 is composed of LiDAR (Light Detection and Ranging), and outputs depth (distance data) as sensor data to the moving body detection device 10. The depth sensor 12 may be provided separately from the image sensor 11, and may be composed of a distance measurement sensor other than LiDAR, such as a ToF sensor.

The moving body detection device 10 is configured to include a feature extraction unit 110, a tracking unit 130, and an alternating optimization unit 150.

The feature extraction unit 110 extracts a feature of each type of object nearby based on image data from the image sensor 11 and sensor data from the depth sensor 12.

Specifically, the feature extraction unit 110 detects a region of each type of object by identifying a class (attribute) for each pixel through instance segmentation using the image data (RGB image) from the image sensor 11, and assigns a unique ID to each region. With the instance segmentation, objects even with the same attribute are recognized as separate objects.

The feature extraction unit 110 also calculates an optical flow of a feature point of each type of object using the image data (RGB images) from the image sensor 11.

Further, the feature extraction unit 110 calculates a depth of a feature point of each type of object using the sensor data from the depth sensor 12. Specifically, the feature extraction unit 110 extracts a depth of a feature point of each type of object by sensor fusion of the image sensor 11 and the depth sensor 12.

The feature extraction unit 110 outputs the feature extracted by its respective type of processing (segmentation, optical flow, depth) together with a reliability calculated for the feature to the tracking unit 130, for example, on a frame-by-frame basis of image data (RGB image).

The tracking unit 130 tracks a moving body (object) based on each feature from the feature extraction unit 110 and its reliability, and outputs a tracking ID, a class, 2D coordinates (u, v), 3D coordinates (x, y, z), and velocity (Vx, Vy, Vz) of the object as the tracking state of that object.

For each object detected in the current frame, the tracking unit 130 outputs binary data indicating whether or not the object is identical to the object in the previous frame to the alternating optimization unit 150 as a tracking result of that object. In the following description, the tracking state of the object will be described as being distinct from the tracking result of the object, but in a broader sense, it can be considered as the tracking result of the object.

The alternating optimization unit 150 corrects errors of the optical flow and the depth for each object, based on each feature and its reliability from the feature extraction unit 110, and the tracking result from the tracking unit 130, and recalculates the centroid coordinates of the object. The corrected optical flow and depth (the corrected optical flow and the corrected depth) are fed back to the feature extraction unit 110, and the recalculated centroid coordinates of each object are fed back to the tracking unit 130.

The tracking unit 130 updates the tracking state (2D coordinates, 3D coordinates, and velocity) of each object based on the centroid coordinates of each object fed back by the alternating optimization unit 150.

With the above configuration, it is possible to further improve the accuracy of object tracking.

Detailed configuration and operation of each unit of the moving body detection device 10 will be described below.

### <3. Configuration of Feature Extraction Unit>

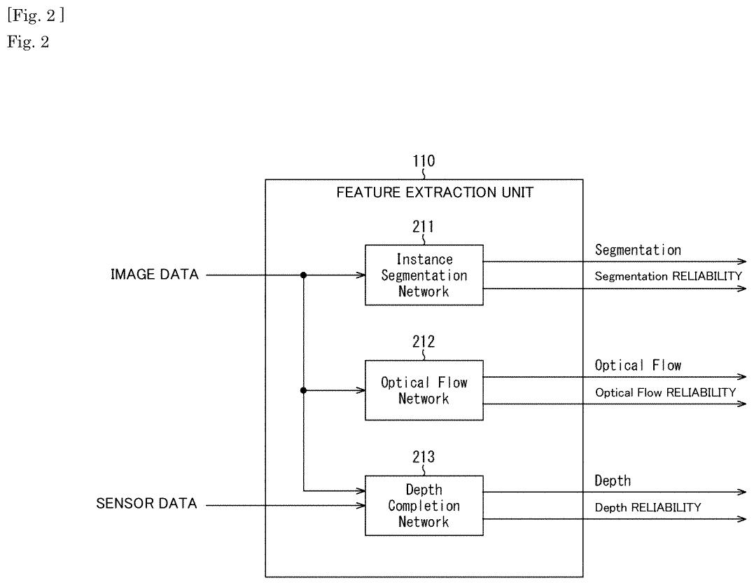

FIG. 2 is a block diagram illustrating a configuration example of the feature extraction unit 110.

As illustrated in FIG. 2, the feature extraction unit 110 is configured to include an instance segmentation network 211, an optical flow network 212, and a depth completion network 213.

The instance segmentation network 211 is a network (model) used for instance segmentation of image data. As the instance segmentation network 211, for example, the network disclosed in He, Kaiming, et al., “Mask r-cnn.” IEEE international conference on computer vision, 2017 may be used.

The optical flow network 212 is a network (model) used to calculate an optical flow for image data. As the optical flow network 212, for example, the network disclosed in Sun, Deqing, et al., “Pwc-net: Cnns for optical flow using pyramid, warping, and cost volume.” IEEE conference on computer vision and pattern recognition, 2018 may be used.

The depth completion network 213 is a network (model) used for depth completion based on image data and sensor data. In general, the distance measurement sensor such as LiDAR or ToF sensor constituting the depth sensor 12 has an aspect of low resolution, which can measure only a partial depth. In contrast, depth completion is a method of complementing the output of the distance measurement sensor to an equivalent level to an RGB image by sensor fusion. This makes it possible to estimate the depth with high resolution and high accuracy. As the depth completion network 213, for example, the network disclosed in Ma, Fangchang, Guilherme Venturelli Cavalheiro, and Sertac Karaman, “Self-Supervised Sparse-to-Dense: Self-Supervised Depth Completion from LiDAR and Monocular Camera.” 2019 International Conference on Robotics and Automation (ICRA), IEEE, 2019 may be used.

The instance segmentation network 211, the optical flow network 212, and the depth completion network 213 calculate reliabilities of the segmentation, the optical flow, and the depth, respectively. For calculating the reliabilities, for example, the network disclosed in Gal, Yarin, and Zoubin Ghahramani, “Dropout as a bayesian approximation: Representing model uncertainty in deep learning.” international conference on machine learning, PMLR, 2016 may be used.

With the above configuration, the feature extraction unit 110 can output the segmentation (the detection result), optical flow, and depth of each type of object, as well as their respective reliabilities.

### <4. Configuration and Operation of Tracking Unit>

### (Configuration of Tracking Unit)

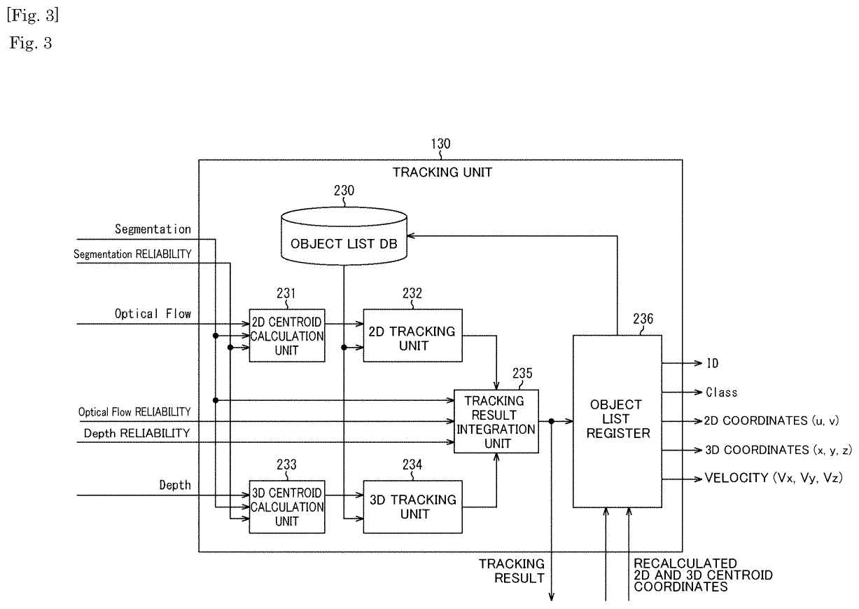

FIG. 3 is a block diagram illustrating a functional configuration example of the tracking unit 130.

As illustrated in FIG. 3, the tracking unit 130 is configured to include an object list DB 230, a 2D centroid calculation unit 231, a 2D tracking unit 232, a 3D centroid calculation unit 233, a 3D tracking unit 234, a tracking result integration unit 235, and an object list register 236.

In the object list DB 230 (hereinafter simply referred to as DB 230), the tracking state of each object (moving body) to be tracked, such as an ID (tracking ID), a class, 2D coordinates, 3D coordinates, and a velocity, is registered, for example, on a frame-by-frame basis.

The 2D centroid calculation unit 231 calculates the 2D centroid coordinates of each object using the segmentation (the detection result of the object) and the optical flow from the feature extraction unit 110. The reliability of the segmentation as well as the detection result of the object and the optical flow may be used to calculate the 2D centroid coordinates of the object.

The 2D tracking unit 232 performs 2D tracking (tracking on image coordinates) of each object based on the 2D centroid coordinates calculated by the 2D centroid calculation unit 231 and the 2D coordinates registered in the DB 230, and outputs the 2D tracking result.

The 3D centroid calculation unit 233 calculates the 3D centroid coordinates of each object using the segmentation (the detection result of the object) and the depth from the feature extraction unit 110. The reliability of the segmentation as well as the detection result of the object and the depth may be used to calculate the 3D centroid coordinates of the object.

The 3D tracking unit 234 performs 3D tracking (tracking on camera coordinates) of each object based on the 3D centroid coordinates calculated by the 3D centroid calculation unit 233 and the 3D coordinates registered in the DB 230, and outputs the 3D tracking result.

The tracking result integration unit 235 performs, based on the segmentation (the detection result of the object) and the reliabilities of the optical flow and the depth from the feature extraction unit 110, integration processing to determine the final tracking result of the object from among the 2D tracking result from the 2D tracking unit 232 and the 3D tracking result from the 3D tracking unit 234. In other words, the tracking result integration unit 235 functions as a selector that selectively outputs either the 2D tracking result or the 3D tracking result.

For each object detected in the current frame, the tracking result integration unit 235 outputs binary data indicating whether or not the object is identical to the object in the previous frame to the object list register 236 and the alternating optimization unit 150 as a tracking result of that object. For each detected object, the tracking result integration unit 235 also outputs, its class, and the 2D centroid coordinates and the 3D centroid coordinates calculated by the 2D centroid calculation unit 231 and the 3D centroid calculation unit, respectively, to the object list register 236.

Based on the tracking result from the tracking result integration unit 235, the object list register 236 (hereinafter simply referred to as the register 236) updates the tracking state or registers the object as a new object depending on whether or not that object has been registered in the DB 230. The configuration and operation of the register 236 will be described in detail later.

### (Flow of 2D Tracking Processing)

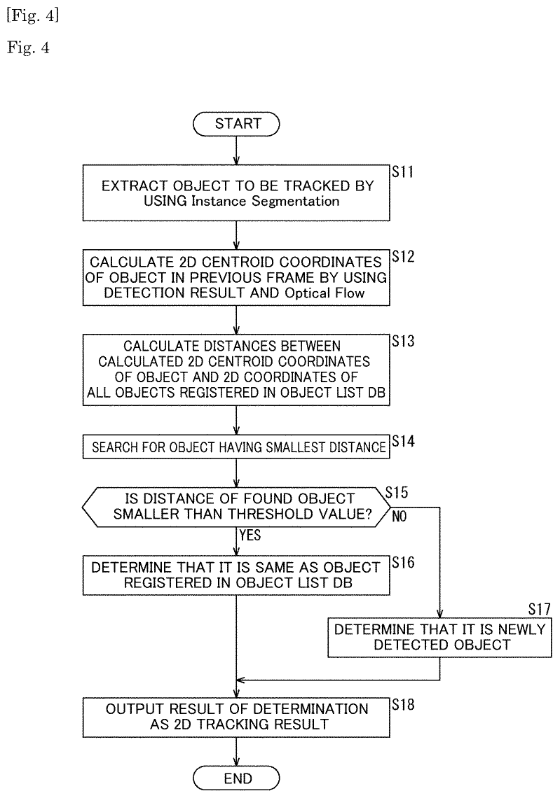

First, a flow of 2D tracking processing performed by the tracking unit 130 will be described with reference to a flowchart of FIG. 4. The processing of FIG. 4 is performed, for example, on a frame-by-frame basis.

In step S11, the 2D centroid calculation unit 231 extracts an object to be tracked (a region that may be a moving body, such as another vehicle, a bicycle, a pedestrian, and a railroad car) by using a result of instance segmentation.

A detection result of an object, Obj(u, v) for image coordinates (u, v) is represented by the following Equation (1) using a result of instance segmentation, I(u, v) and a label L indicating a region that may be a moving body.

$$[ Math . 1 ]$$

$$Obj ( u , v ) = \{ \begin{matrix}1 , & I ( u , v ) ∈ L \\ 0 , & otherwise\end{matrix} \qquad ( 1 )$$

In step S12, the 2D centroid calculation unit 231 calculates the 2D centroid coordinates of the object in the previous frame by using the detection result Obj(u, v) and an optical flow.

When optical flows in u and v directions at the image coordinates (u, v) are Fu(u, v) and Fv(u, v), the 2D centroid coordinates (Cu_{2D}, CV_{2D}) are calculated by a simple average of the optical flows and image coordinates within the region by using the following Equation (2).

$$\begin{matrix}[ Math . 2 ] & \\ {Cu}_{2 D} = \frac{Obj ( u , v ) \{ u + Fu ( u , v ) \}}{\sum Obj ( u , v )} {Cv}_{2 D} = \frac{Obj ( u , v ) \{ v + Fv ( u , v ) \}}{\sum Obj ( u , v )} & ( 2 )\end{matrix}$$

The 2D centroid coordinates (Cu_{2D}, CV_{2D}) may be calculated by the following Equation (3) using a weighted average with the reliability of the instance segmentation, C_{seg}(u, v).

$$\begin{matrix}[ Math . 3 ] & \\ {Cu}_{2 D} = \frac{{C}_{seg} ( u , v ) Obj ( u , v ) \{ u + Fu ( u , v ) \}}{\sum {C}_{seg} ( u , v ) Obj ( u , v )} {Cv}_{2 D} = \frac{{C}_{s e g} ( u , v ) Obj ( u , v ) \{ v + Fv ( u , v ) \}}{\sum {C}_{seg} ( u , v ) Obj ( u , v )} & ( 3 )\end{matrix}$$

In step S13, the 2D tracking unit 232 calculates Euclidean distances between the 2D centroid coordinates in the previous frame calculated by the 2D centroid calculation unit 231 and the 2D coordinates of all objects in the previous frame registered in the object list DB 230.

In step S14, the 2D tracking unit 232 searches the calculated Euclidean distances for an object having the smallest distance.

In step S15, the 2D tracking unit 232 determines whether or not the distance of the found object is smaller than a threshold value. If it is determined that the distance of the found object is smaller than the threshold value, the processing proceeds to step S16.

In step S16, the 2D tracking unit 232 determines that the object is the same as an object registered in the object list DB 230.

On the other hand, if it is determined in step S15 that the distance of the found object is larger than the threshold value, the processing proceeds to step S17.

In step S17, the 2D tracking unit 232 determines that the object is a newly detected object that is not registered in the object list DB 230.

The above-described threshold value may be dynamically changed according to the class (attribute) of the object detected by the instance segmentation. For example, if the detected object is a moving body with a relatively high velocity, such as another vehicle or a railway car, the threshold value is set to a larger value, and if the detected object is a moving body with a relatively low velocity, such as a bicycle or a pedestrian, the threshold value is set to a smaller value.

After the determination in step S16 or step S17, the processing proceeds to step S18, where the 2D tracking unit 232 outputs the result of the determination for the object to the tracking result integration unit 235 as a 2D tracking result.

In the above processing, the 2D centroid coordinates are calculated using a weighted average based on the reliability of the instance segmentation, making it possible to reduce the influence of pixels where the result of the instance segmentation may be erroneous. As a result, it is possible to calculate the 2D centroid coordinates with higher accuracy than with conventional methods.

### (Flow of 3D Tracking Processing)

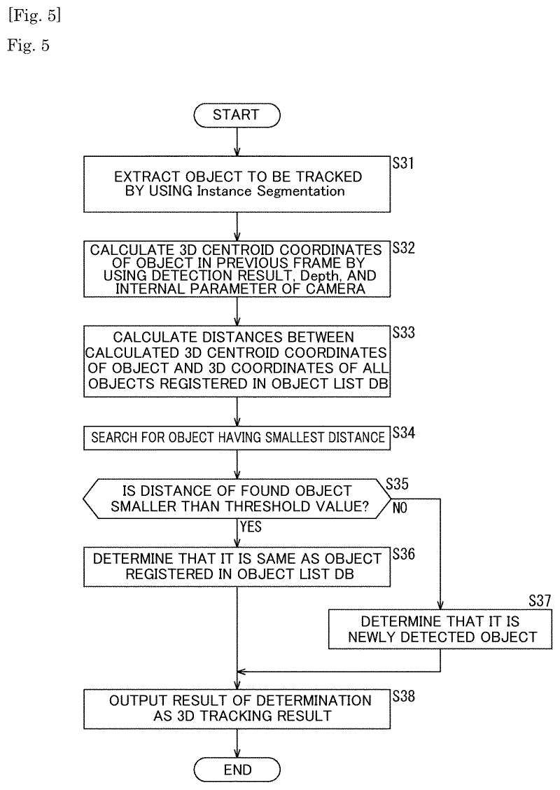

Next, a flow of 3D tracking processing performed by the tracking unit 130 will be described with reference to a flowchart of FIG. 5. The processing of FIG. 5 is also performed on a frame-by-frame basis.

In step S31, the 3D centroid calculation unit 233 extracts an object to be tracked (a region that may be a moving body, such as another vehicle, a bicycle, a pedestrian, and a railroad car) by using a result of instance segmentation.

A detection result of an object, Obj(u, v) for image coordinates (u, v) is represented by Equation (1) described above.

In step S32, the 3D centroid calculation unit 233 calculates the 3D centroid coordinates of the object in the current frame by using the detection result Obj(u, v), the depth, and an internal parameter of the RGB camera (image sensor 11).

The internal parameter K of the RGB camera are represented by the following Equation (4).

$$\begin{matrix}[ Math . 4 ] & \\ K = [ \begin{matrix}{f}_{x} & 0 & {x}_{0} \\ 0 & {f}_{y} & {y}_{0} \\ 0 & 0 & 1\end{matrix} ] & ( 4 )\end{matrix}$$

When the depth at the image coordinates (u, v) is D(u, v), the 3D centroid coordinates (Cx_{3D}, Cy_{3D}, Cz_{3D}) are calculated by a simple average of the camera coordinates within the region using the following Equation (5).

$$\begin{matrix}[ Math . 5 ] & \\ C {x}_{3 D} = \frac{Obj ( u , v ) ( u - {x}_{0} ) D ( u , v ) / {f}_{x}}{\sum Obj ( u , v )} {Cy}_{3 D} = \frac{Obj ( u , v ) ( v - {y}_{0} ) D ( u , v ) / {f}_{y}}{\sum Obj ( u , v )} {Cz}_{3 D} = \frac{Obj ( u , v ) D ( u , v )}{\sum Obj ( u , v )} & ( 5 )\end{matrix}$$

The 3D centroid coordinates (Cx_{3D}, Cy_{3D}, Cz_{3D}) may be calculated by the following Equation (6) using a weighted average with the reliability of the instance segmentation, C_{seg}(u, v).

$$\begin{matrix}[ Math . 6 ] & \\ C {x}_{3 D} = \frac{{C}_{s e g} ( u , v ) Obj ( u , v ) ( u - {x}_{0} ) D ( u , v ) / {f}_{x}}{\sum {C}_{s e g} ( u , v ) Obj ( u , v )} C {y}_{3 D} = \frac{{C}_{s e g} ( u , v ) Obj ( u , v ) ( u - {y}_{0} ) D ( u , v ) / {f}_{y}}{\sum {C}_{s e g} ( u , v ) Obj ( u , v )} {Cz}_{3 D} = \frac{{C}_{s e g} ( u , v ) Obj ( u , v ) D ( u , v )}{\sum {C}_{s e g} ( u , v ) Obj ( u , v )} & ( 6 )\end{matrix}$$

In step S33, the 3D tracking unit 234 calculates Euclidean distances between the 3D centroid coordinates in the current frame calculated by the 3D centroid calculation unit 233 and the 3D coordinates of all objects in the previous frame registered in the object list DB 230.

In step S34, the 3D tracking unit 234 searches the calculated Euclidean distances for an object having the smallest distance.

In step S35, the 3D tracking unit 234 determines whether or not the distance of the found object is smaller than a threshold value. If it is determined that the distance of the found object is smaller than the threshold value, the processing proceeds to step S36.

In step S36, the 3D tracking unit 234 determines that the object is the same as an object registered in the object list DB 230.

On the other hand, if it is determined in step S35 that the distance of the found object is larger than the threshold value, the processing proceeds to step S37.

In step S37, the 3D tracking unit 234 determines that the object is a newly detected object that is not registered in the object list DB 230.

The above-described threshold value may also be dynamically changed according to the class (attribute) of the object detected by the instance segmentation.

After the determination in step S36 or step S37, the processing proceeds to step S38, where the 3D tracking unit 234 outputs the result of the determination for the object to the tracking result integration unit 235 as a 3D tracking result.

In the above processing, the 3D centroid coordinates are calculated using a weighted average based on the reliability of the instance segmentation, making it possible to reduce the influence of pixels where the result of the instance segmentation may be erroneous. As a result, it is possible to calculate the 3D centroid coordinates with higher accuracy than with conventional techniques.

### (Flow of Tracking Result Integration Processing)

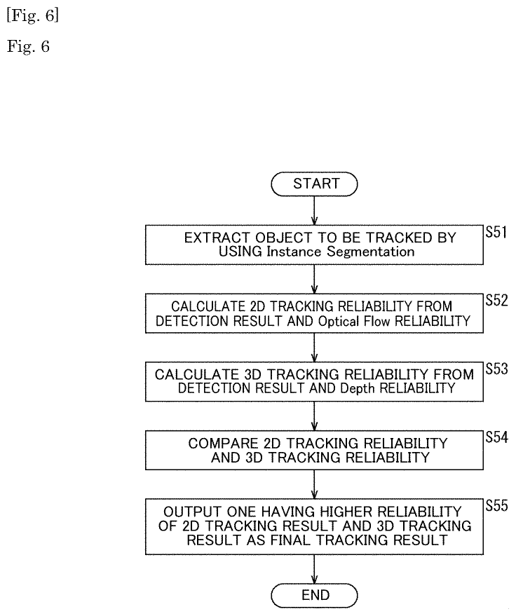

Finally, a flow of tracking result integration processing performed by the tracking unit 130 will be described with reference to a flowchart of FIG. 6.

In step S51, the tracking result integration unit 235 extracts an object to be tracked (a region that may be a moving body, such as another vehicle, a bicycle, a pedestrian, and a railroad car) by using a result of instance segmentation.

A detection result of an object, Obj(u, v) for image coordinates (u, v) is represented by Equation (1) described above.

In step S52, the tracking result integration unit 235 calculates a 2D tracking reliability, which is the reliability of the optical flow for each object, from the detection result Obj(u, v) and the optical flow reliability.

When the optical flow reliability is Cr(u, v), the 2D tracking reliability, C_{2D} is calculated by the following Equation (7).

$$\begin{matrix}[ Math . 7 ] & \\ {C}_{2 D} = \frac{{C}_{f} ( u , v ) Obj ( u , v )}{\sum {C}_{f} ( u , v ) Obj ( u , v )} & ( 7 )\end{matrix}$$

In step S53, the tracking result integration unit 235 calculates a 3D tracking reliability, which is the reliability of the depth for each object, from the detection result Obj(u, v) and the depth reliability.

When the depth reliability is C_{d}(u, v), the 3D tracking reliability C_{3D} is calculated by the following Equation (8).

$$\begin{matrix}[ Math . 8 ] & \\ {C}_{3 D} = \frac{{C}_{d} ( u , v ) Obj ( u , v )}{\sum {C}_{d} ( u , v ) Obj ( u , v )} & ( 8 )\end{matrix}$$

In step S54, the tracking result integration unit 235 compares, for each object, the 2D tracking reliability C_{2D} and the 3D tracking reliability C_{3D}.

In step S55, the tracking result integration unit 235 outputs, for each object, the higher of the 2D tracking reliability C_{2D} and the 3D tracking reliability C_{3D} as the final tracking result. For example, when the 2D tracking reliability C_{2D} for a certain object is higher than the 3D tracking reliability C_{2D} for the certain object, the 2D tracking result is output as the final tracking result of that object. For example, when the 3D tracking reliability C_{3D} for a certain object is higher than the 2D tracking reliability C_{2D} for the certain object, the 3D tracking result is output as the final tracking result of that object.

According to the above processing, it is possible to continue to use the 2D tracking result or the 3D tracking result, whichever is assumed to be more accurate, and as a result, it is possible to improve the accuracy of object tracking compared to conventional methods.

### <5. Configuration and Operation of Alternating Optimization Unit and Register>

### (Configuration of Alternating Optimization Unit and Register)

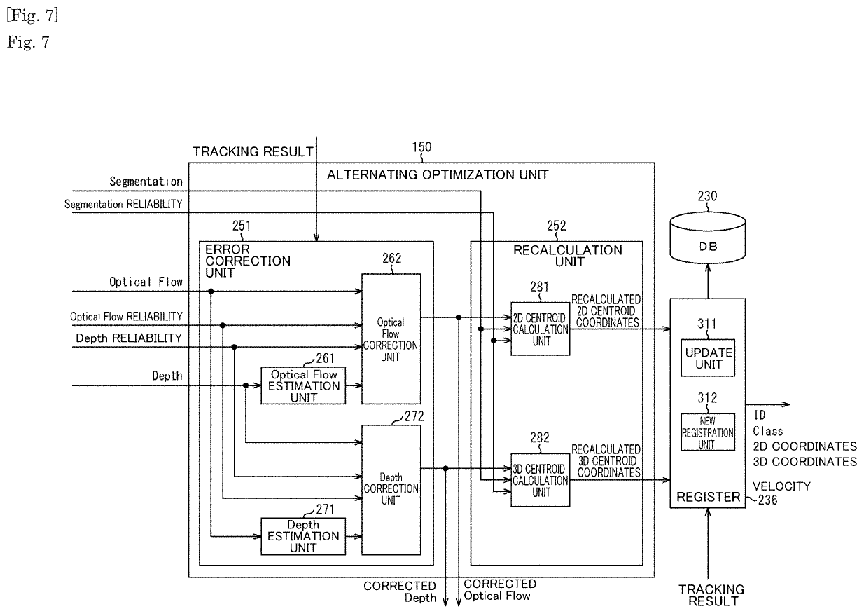

FIG. 7 is a block diagram illustrating a functional configuration example of the alternating optimization unit 150 and the register 236.

As illustrated in FIG. 7, the alternating optimization unit 150 is configured to include an error correction unit 251 and a recalculation unit 252.

Based on the tracking result of the object based on the 2D tracking using the optical flow and the 3D tracking using the depth in the tracking unit 130, the error correction unit 251 corrects errors of the optical flow and the depth. Specifically, the error correction unit 251 corrects the errors of the optical flow and the depth by using the tracking result of each object in the tracking unit 130 and the reliabilities of the optical flow and the depth.

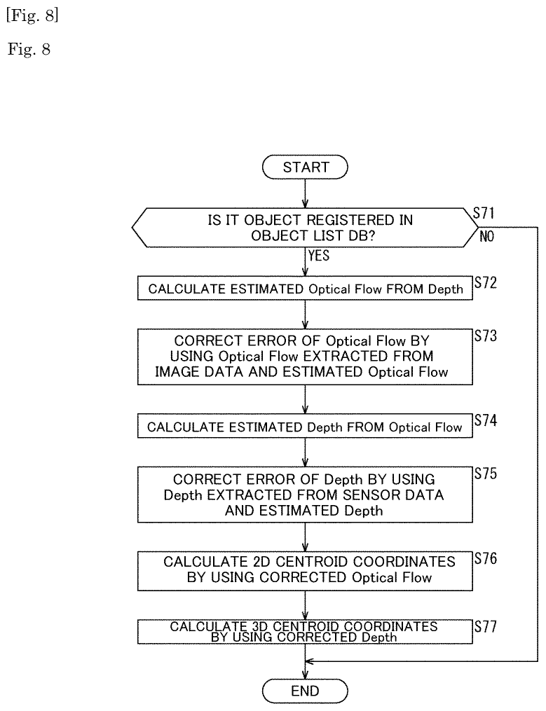

The error correction unit 251 includes an optical flow estimation unit 261, an optical flow correction unit 262, a depth estimation unit 271, and a depth correction unit 272. The function of each unit included in the error correction unit 251 will be described later with reference to a flowchart of FIG. 8.

The recalculation unit 252 recalculates the centroid coordinates of the object by using the optical flow and depth corrected by the error correction unit 251. Specifically, the recalculation unit 252 calculates (recalculates) the 2D centroid coordinates and the 3D centroid coordinates of each object by using the corrected optical flow and depth, and the segmentation (the detection result of the object). In addition to the above information, the 2D centroid coordinates and the 3D centroid coordinates of each object may be calculated (recalculated) using the reliability of the segmentation.

The recalculation unit 252 includes a 2D centroid calculation unit 281 and a 3D centroid calculation unit 282. The 2D centroid calculation unit 281 and the 3D centroid calculation unit 282 have the same functions as the 2D centroid calculation unit 231 and the 3D centroid calculation unit 233 described with reference to FIG. 3, respectively, and thus the description thereof will not be repeated.

As illustrated in FIG. 7, the register 236 is configured to include an update unit 311 and a new registration unit 312.

The update unit 311 updates the tracking state (tracking result) of the object based on the optical flow and depth corrected by the error correction unit 251. Specifically, the update unit 311 updates the 2D centroid coordinates and 3D centroid coordinates, which serve as the tracking state, of the object registered in the DB 230, by using the centroid coordinates (2D centroid coordinates and 3D centroid coordinates) recalculated by the recalculation unit 252 using the optical flow and depth corrected by the recalculation unit 252.

The new registration unit 312 newly registers the class, 2D centroid coordinates, 3D centroid coordinates, and the like output by the tracking result integration unit 235 for an object not registered in the DB 230.

### (Operation Flow of Alternating Optimization Unit)

An operation flow of the alternating optimization unit 150 will now be described with reference to the flowchart of FIG. 8. The processing of FIG. 8 is performed for each object extracted to be tracked.

In step S71, the error correction unit 251 determines, based on the tracking result from the tracking result integration unit 235, whether or not the object is an object registered in the object list DB 230. If it is determined that the object is registered in object list DB 230, that is, when the object detected in the current frame is an object that has appeared in the previous frames, the processing proceeds to step S72.

In step S72, the optical flow estimation unit 261 of the error correction unit 251 calculates an estimated optical flow estimated from the depth for each pixel of the object. Now given that the internal parameter K of the RGB camera and an external parameter [R|t] are known, an estimated optical flow Fa at image coordinates S estimated from three-dimensional coordinates W of the depth (point cloud data) is calculated by the following Equation (9).

$$\begin{matrix}[ Math . 9 ] & \\ {F}_{d} = {K [ {R}^{′} \vert {t}^{′} ] [ R \vert t ]}^{- 1} {K}^{- 1} S - S & ( 9 )\end{matrix}$$

Equation (9) is obtained as follows. Given that the image coordinates in a previous frame are S=K [R|t]W and the image coordinates in the current frame are S′=K [R′|t′]W, the estimated optical flow Fa is represented by the following Equation (10).

$$\begin{matrix}[ Math . 10 ] & \\ \begin{matrix}{F}_{d} = {S}^{′} - S \\ = K [ {R}^{′} \vert t ] W - S\end{matrix} & ( 10 )\end{matrix}$$

Then, by substituting W=[R|t]⁻¹K⁻¹S into Equation (10), Equation (9) described above is obtained.

In step S73, the optical flow correction unit 262 of the error correction unit 251 corrects the error of the optical flow by using the optical flow extracted from the image data and the estimated optical flow calculated by the optical flow estimation unit 261.

The corrected optical flow F(u, v) at image coordinates (u, v) is obtained by data fusion of the optical flow Fₙₑₜ extracted by the feature extraction unit 110 and the estimated optical flow Fa estimated from the depth according to the reliability C_{f} of the optical flow and the reliability C_{d} of the depth, as represented by the following Equation (11). In other words, for each pixel, the optical flow with the highest reliability is adopted.

$$\begin{matrix}[ Math . 11 ] & \\ F ( u , v ) = \{ \begin{matrix}{F}_{net} ( u , v ) , & {C}_{f} ( u , v ) \geq {C}_{d} ( u , v ) \\ {F}_{d} ( u , v ) , & {C}_{f} ( u , v ) < {C}_{d} ( u , v )\end{matrix} & ( 11 )\end{matrix}$$

In step S74, the depth estimation unit 271 of the error correction unit 251 calculates, for each pixel of the object, an estimated depth estimated from the optical flow. An estimated depth D_{f} estimated from an optical flow F before correction is calculated by the following Equation (12).

$$\begin{matrix}[ Math . 12 ] & \\ {D}_{f} = {[ R \vert t ]}^{- 1} {K}^{-} ( {S}^{′} - F ) & ( 12 )\end{matrix}$$

Equation (12) is obtained as follows. Given that the image coordinates in a previous frame are S=K[R|t]W and the image coordinates in the current frame are S′=K[R′|t′]W, the optical flow F before correction is represented as the following Equation (13).

$$\begin{matrix}[ Math . 13 ] & \\ F = {S}^{′} - K [ R \vert t ] W K [ R \vert t ] W = {S}^{′} - F & ( 13 )\end{matrix}$$

Then, by transforming Equation (13) with respect to the three-dimensional coordinates W (i.e., the estimated depth D_{f}), Equation (12) described above is obtained.

In step S75, the depth correction unit 272 of the error correction unit 251 corrects the error of the depth by using the optical flow extracted from the sensor data and the estimated depth calculated by the depth estimation unit 271.

The corrected depth D(u, v) at image coordinates (u, v) is obtained by data fusion of the depth Dₙₑₜ extracted by the feature extraction unit 110 and the estimated depth D_{f} estimated from the optical flow according to the reliability of the depth, C_{d} and the reliability of the optical flow, C_{f}, as represented by the following Equation (14). In other words, for each pixel, the depth with the highest reliability is adopted.

$$\begin{matrix}[ Math . 14 ] & \\ D ( u , v ) = \{ \begin{matrix}{D}_{net} ( u , v ) , & {C}_{d} ( u , v ) \geq {C}_{f} ( u , v ) \\ {D}_{f} ( u , v ) , & {C}_{d} ( u , v ) < {C}_{f} ( u , v )\end{matrix} & ( 14 )\end{matrix}$$

The corrected optical flow and corrected depth thus obtained are output to the recalculation unit 252 and are also fed back to the feature extraction unit 110.

In step S76, the 2D centroid calculation unit 281 of the recalculation unit 252 calculates (recalculates) the 2D centroid coordinates of the object in the previous frame by using the corrected optical flow.

When corrected optical flows in u and v directions at the image coordinates (u, v) are Fu(u, v) and Fv(u, v), the 2D centroid coordinates (Cu_{2D}, CV_{2D}) are calculated by the following Equation (15).

$$\begin{matrix}[ Math . 15 ] & \\ C {u}_{2 D} = \frac{{C}_{s e g} ( u , v ) Obj ( u , v ) \{ u + Fu ( u , v ) \}}{\sum {C}_{s e g} ( u , v ) Obj ( u , v )} {Cv}_{2 D} = \frac{{C}_{s e g} ( u , v ) Obj ( u , v ) \{ v + Fv ( u , v ) \}}{\sum {C}_{s e g} ( u , v ) Obj ( u , v )} & ( 15 )\end{matrix}$$

The 2D centroid coordinates (Cu_{2D}, CV_{2D}) in Equation (15) are recalculated using a weighted average with the reliability of the instance segmentation, C_{seg}(u, v), as in Equation (3) described above. Alternatively, the 2D centroid coordinates (Cu_{2D}, CV_{2D}) may be recalculated by a simple average of the optical flow and the image coordinates within the region, as in Equation (2) described above.

In step S77, the 3D centroid calculation unit 283 of the recalculation unit 252 calculates (recalculates) the 3D centroid coordinates of the object in the current frame by using the corrected depth.

When the depth at the image coordinates (u, v) is D(u, v), the 3D centroid coordinates (Cx_{3D}, Cy_{3D}, Cz_{3D}) are calculated by the following Equation (16).

$$\begin{matrix}[ Math . 16 ] & \\ C {x}_{3 D} = \frac{{C}_{s e g} ( u , v ) Obj ( u , v ) ( u - {x}_{0} ) D ( u , v ) / {f}_{x}}{\sum {C}_{seg} ( u , v ) Obj ( u , v )} C {y}_{3 D} = \frac{{C}_{s e g} ( u , v ) Obj ( u , v ) ( v - {y}_{0} ) D ( u , v ) / {f}_{y}}{\sum {C}_{seg} ( u , v ) Obj ( u , v )} {Cz}_{3 D} = \frac{{C}_{s e g} ( u , v ) Obj ( u , v ) D ( u , v )}{\sum {C}_{seg} ( u , v ) Obj ( u , v )} & ( 16 )\end{matrix}$$

The 3D centroid coordinates (Cx_{3D}, Cy_{3D}, Cz_{3D}) in Equation (16) are recalculated using a weighted average with the reliability of the instance segmentation, C_{seg}(u, v), as in Equation (6) described above. Alternatively, the 3D centroid coordinates (Cx_{3D}, Cy_{3D}, Cz_{3D}) may be recalculated by a simple average of the optical flow and the image coordinates within the region, as in Equation (5) described above.

The recalculated 2D and 3D centroid coordinates thus obtained are fed back to the register (object list register) 236 of the tracking unit 130.

As described above, when an object is being tracked, it means that the object is identified over the current and previous frames. If there is any inconsistency in the relationship between the optical flow and the depth, it needs to be corrected as an error.

On the other hand, if it is determined in step S71 that the object is not an object registered in the object list DB 230, steps S72 to S77 are skipped. In other words, when the object detected in the current frame is a newly detected object, there is a high possibility that there is no corresponding optical flow and thus, the processing of steps S72 to S77 are not performed.

### (Operation Flow of Register)

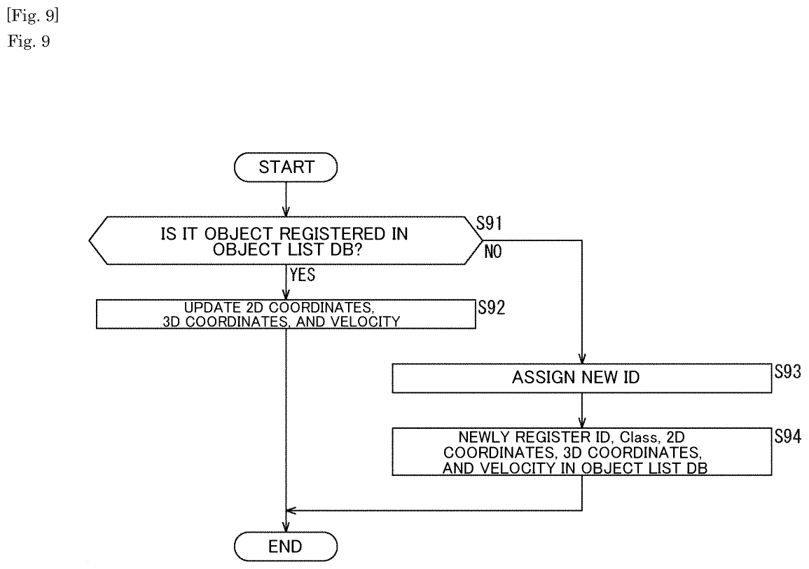

Next, an operation flow of the register 236 will be described with reference to a flowchart of FIG. 9. The processing of FIG. 9 is also performed for each object extracted to be tracked.

In step S91, the register 236 determines, based on the tracking result from the tracking result integration unit 235, whether or not the object is an object registered in the object list DB 230. If it is determined that the object is registered in object list DB 230, that is, when the object detected in the current frame is an object that has appeared in the previous frames, the processing proceeds to step S92.

In step S92, the update unit 311 of the register 236 updates the 2D coordinates, 3D coordinates, and velocity of the object registered in the object list DB 230 based on the recalculated 2D centroid coordinates and 3D centroid coordinates. Specifically, the 2D coordinates and 3D coordinates registered in the object list DB 230 are replaced with the recalculated 2D centroid coordinates and 3D centroid coordinates. Moreover, the velocity registered in the object list DB 230 is calculated by multiplying the difference between the 3D coordinates before update and the 3D coordinates after update by the frame rate of the RGB camera.

On the other hand, if it is determined in step S91 that the object is not an object registered in the object list DB230, that is, when the object detected in the current frame is a newly detected object, the processing proceeds to step S93.

In step S93, the new registration unit 312 of the register 236 assigns a new ID (tracking ID) to the newly detected object.

Then, in step S94, the new registration unit 312 newly registers the ID, class, 2D coordinates, 3D coordinates, and velocity of the object in the object list DB 230. As the ID, a newly assigned ID is registered, and as the class, 2D coordinates, and 3D coordinates, the class, 2D centroid coordinates, and 3D centroid coordinates output from the tracking result integration unit 235 are registered. The velocity is registered as 0.

According to the above processing (the operation of the alternating optimization unit 150 and the register 236), it is possible to obtain optical flow and depth with higher accuracy than the optical flow and depth extracted by the feature extraction unit 110. In addition, by using the optical flow and depth with improved accuracy to recalculate the centroid coordinates of the object and update the tracking state of the object, it is possible to improve the accuracy of object tracking as time passes (as the frames progress).

### <6. Optimization of Network>

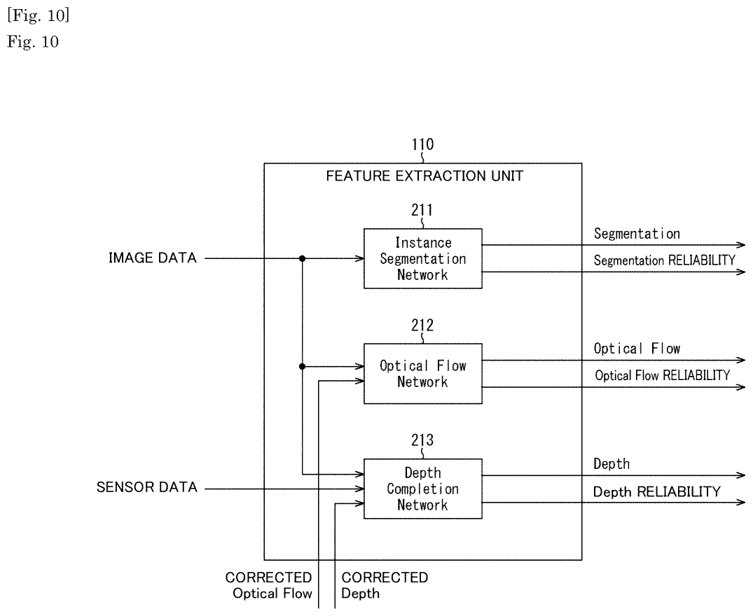

As illustrated in FIG. 10, the corrected optical flow and corrected depth obtained by the error correction unit 251 are fed back to the feature extraction unit 110. Thus, the feature extraction unit 110 can optimize the network based on the corrected optical flow and depth in a previous frame.

Specifically, the feature extraction unit 110 modifies the optical flow network 212 so as to predict the optical flow in the current frame by using the image data in the current and previous frames and the corrected optical flow in the previous frame.

The feature extraction unit 110 also modifies the depth completion network 213 so as to predict the depth in the current frame by using the image data and sensor data in the current frame and the corrected depth in the previous frame.

This makes it possible to improve the accuracy of optical flow and depth as time passes (as the frames progress), which in turn makes it possible to improve the accuracy of object tracking.

### <7. Configuration Example of Computer>

The above-described series of processing can also be performed by hardware or software. In a case where the series of processing is performed by software, a program that constitutes the software is installed on a computer. In this case, the computer includes, for example, a computer built into dedicated hardware and a general-purpose personal computer in which various programs are installed to enable the personal computer to execute various types of functions.

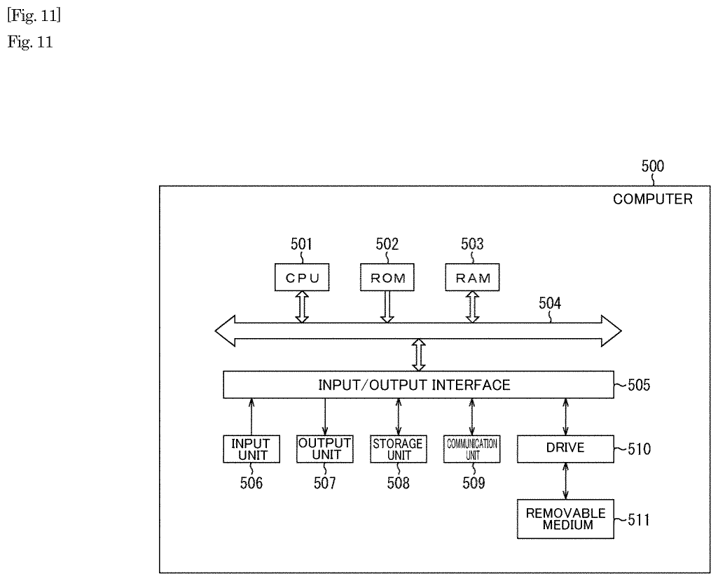

FIG. 11 is a block diagram illustrating a configuration example of computer hardware that performs the above-described series of processing using a program.

In the computer, a central processing unit (CPU) 501, a read-only memory (ROM) 502, and a random access memory (RAM) 503 are connected to one another via a bus 504.

An input/output interface 505 is further connected to the bus 504. An input unit 506, an output unit 507, a storage unit 508, a communication unit 509, and a drive 510 are connected to the input/output interface 505.

The input unit 506 is a keyboard, a mouse, a microphone, or the like. The output unit 507 is a display, a speaker, or the like. The storage unit 508 is a hard disk, non-volatile memory, or the like. The communication unit 509 is a network interface or the like. The drive 510 drives a removable medium 511 such as a magnetic disk, an optical disc, a magneto-optical disk, or semiconductor memory.

In the computer that has the above configuration, for example, the CPU 501 performs the above-described series of processes by loading a program stored in the storage unit 508 to the RAM 503 via the input/output interface 505 and the bus 504 and executing the program.

The program executed by the computer (the CPU 501) can be recorded on, for example, the removable medium 511 serving as a package medium for supply. The program can be supplied via a wired or wireless transfer medium such as a local area network, the Internet, or digital satellite broadcasting.

In the computer, by mounting the removable medium 511 on the drive 510, it is possible to install the program in the storage unit 508 via the input/output interface 505. The program can be received by the communication unit 509 via a wired or wireless transfer medium to be installed in the storage unit 508. In addition, this program may be installed in advance in the ROM 502 or the storage unit 508.

The program executed by a computer may be a program that performs processing chronologically in the order described in the present specification or may be a program that performs processing in parallel or at a necessary timing such as a called time.

The embodiments of the present disclosure are not limited to the above-described embodiments, and various modifications can be made without departing from the essential spirit of the present disclosure.

The advantageous effects described herein are merely exemplary and are not limited, and other advantageous effects may be obtained.

Furthermore, the present disclosure can be configured as follows.

(1)

An information processing device including:
a correction unit that corrects, based on a tracking result of an object based on 2D tracking using an optical flow and 3D tracking using a depth, errors of the optical flow and the depth; and an update unit that updates the tracking result based on the corrected optical flow and depth.
   (2)

The information processing device according to (1), wherein the correction unit corrects the errors of the optical flow and the depth by using reliabilities of the optical flow and the depth.

(3)

The information processing device according to (2), wherein the update unit updates the tracking result based on centroid coordinates of the object recalculated using the corrected optical flow and depth.

(4)

The information processing device according to (3), wherein the correction unit corrects the error of the depth by performing data fusion of the depth extracted from sensor data and an estimated depth estimated from the optical flow, according to the reliabilities of the optical flow and the depth.

(5)

The information processing device according to (3), wherein the correction unit corrects the error of the optical flow by performing data fusion of the optical flow extracted from image data and an estimated optical flow estimated from the depth, according to the reliabilities of the optical flow and the depth.

(6)

The information processing device according to any one of (3) to (5), further including a tracking result integration unit that performs integration processing of obtaining as the tracking result of the object either a 2D tracking result of the object or a 3D tracking result of the object based on a detection result of the object obtained by performing instance segmentation on image data and based on the reliabilities of the optical flow and the depth.

(7)

The information processing device according to (6), wherein the tracking result integration unit performs the integration processing by comparing a 2D tracking reliability calculated from the detection result of the object and the reliability of the optical flow with a 3D tracking reliability calculated from the detection result of the object and the reliability of the depth.

(8)

The information processing device according to (6) or (7), further including a 2D centroid calculation unit that calculates 2D centroid coordinates of the object by using the detection result of the object, the optical flow, and a reliability of the instance segmentation, wherein the 2D tracking result of the object is output based on the 2D centroid coordinates.

(9)

The information processing device according to (6) or (7), further including a 3D centroid calculation unit that calculates 3D centroid coordinates of the object by using the detection result of the object, the depth, and a reliability of the instance segmentation, wherein the 3D tracking result of the object is output based on the 3D centroid coordinates.

(10)

The information processing device according to any one of (1) to (9), further including a feature extraction unit that extracts, by using a network, the optical flow from image data and the depth from sensor data, wherein the feature extraction unit optimizes the network based on the corrected optical flow and depth in a previous frame.

(11)

The information processing device according to (10), wherein the feature extraction unit extracts the depth by sensor fusion of an image sensor and a depth sensor separate from the image sensor.

(12)

The information processing device according to (11), wherein the depth sensor includes LiDAR.

(13)

An information processing method including: by an information processing device, correcting, based on a tracking result of an object based on 2D tracking using an optical flow and 3D tracking using a depth, errors of the optical flow and the depth; and updating the tracking result based on the corrected optical flow and depth.

(14)

A computer-readable recording medium having recorded thereon a program for executing processing of correcting, based on a tracking result of an object based on 2D tracking using an optical flow and 3D tracking using a depth, errors of the optical flow and the depth; and updating the tracking result based on the corrected optical flow and depth.

### REFERENCE SIGNS LIST

10 Moving body detection device
11 Image sensor
12 Depth sensor
110 Feature extraction unit
130 Tracking unit
150 Alternating optimization unit
230 Tracking list DB
231 2D centroid calculation unit
232 2D tracking unit
233 3D centroid calculation unit
234 3D tracking unit
235 Tracking result integration unit
236 Object list register
251 Error correction unit
252 Recalculation unit
261 Optical flow estimation unit
262 Optical flow correction unit
271 Depth estimation unit
272 Depth correction unit
281 2D centroid calculation unit
282 3D centroid calculation unit
311 Update unit
312 New registration unit

1. An information processing device comprising:
a correction unit that corrects, based on a tracking result of an object based on 2D tracking using an optical flow and 3D tracking using a depth, errors of the optical flow and the depth; and
an update unit that updates the tracking result based on the corrected optical flow and depth.

2. The information processing device according to claim 1, wherein the correction unit corrects the errors of the optical flow and the depth by using reliabilities of the optical flow and the depth.

3. The information processing device according to claim 2, wherein the update unit updates the tracking result based on centroid coordinates of the object recalculated using the corrected optical flow and depth.

4. The information processing device according to claim 3, wherein the correction unit corrects the error of the depth by performing data fusion of the depth extracted from sensor data and an estimated depth estimated from the optical flow, according to the reliabilities of the optical flow and the depth.

5. The information processing device according to claim 3, wherein the correction unit corrects the error of the optical flow by performing data fusion of the optical flow extracted from image data and an estimated optical flow estimated from the depth, according to the reliabilities of the optical flow and the depth.

6. The information processing device according to claim 3, further comprising a tracking result integration unit that performs integration processing of obtaining as the tracking result of the object either a 2D tracking result of the object or a 3D tracking result of the object based on a detection result of the object obtained by performing instance segmentation on image data and based on the reliabilities of the optical flow and the depth.

7. The information processing device according to claim 6, wherein the tracking result integration unit performs the integration processing by comparing a 2D tracking reliability calculated from the detection result of the object and the reliability of the optical flow with a 3D tracking reliability calculated from the detection result of the object and the reliability of the depth.

8. The information processing device according to claim 6, further comprising a 2D centroid calculation unit that calculates 2D centroid coordinates of the object by using the detection result of the object, the optical flow, and a reliability of the instance segmentation,
wherein the 2D tracking result of the object is output based on the 2D centroid coordinates.

9. The information processing device according to claim 6, further comprising a 3D centroid calculation unit that calculates 3D centroid coordinates of the object by using the detection result of the object, the depth, and a reliability of the instance segmentation,
wherein the 3D tracking result of the object is output based on the 3D centroid coordinates.

10. The information processing device according to claim 1, further comprising a feature extraction unit that extracts, by using a network, the optical flow from image data and the depth from sensor data,
wherein the feature extraction unit optimizes the network based on the corrected optical flow and depth in a previous frame.

11. The information processing device according to claim 10, wherein the feature extraction unit extracts the depth by sensor fusion of an image sensor and a depth sensor separate from the image sensor.

12. The information processing device according to claim 11, wherein the depth sensor includes Light Detection and Ranging (LiDAR).

13. An information processing method comprising: by an information processing device,
correcting, based on a tracking result of an object based on 2D tracking using an optical flow and 3D tracking using a depth, errors of the optical flow and the depth; and
updating the tracking result based on the corrected optical flow and depth.

14. A computer-readable recording medium having recorded thereon a program for executing processing of correcting, based on a tracking result of an object based on 2D tracking using an optical flow and 3D tracking using a depth, errors of the optical flow and the depth; and
updating the tracking result based on the corrected optical flow and depth.
